(19) United States
(12) Patent Application Publication
(10) Pub. No.: US 2019/0303305 A1
(43) Pub. Date: Oct. 3, 2019

(54) SYSTEMS AND METHODS FOR PROVIDING SECURE MEMORY

(71) Applicant: Symantec Corporation, Mountain View, CA (US)

(72) Inventors: Haik Mesropian, Glendale, CA (US); Costin Ionescu, Redondo Beach, CA (US); Melissa Mendonca, Los Angeles, CA (US); Tirth Sanyal, Rancho Palos Verdes, CA (US)

(21) Appl. No.: 15/940,589

(22) Filed: Mar. 29, 2018

(51) Int. Cl. G06F 12/14; G06F 3/06; G06F 21/57; G06F 21/44; G06F 9/455; G06F 21/62

(52) U.S. Cl. CPC G06F 12/1408; G06F 3/0622; G06F 3/0631; G06F 3/0673; G06F 2009/45583; G06F 21/44; G06F 9/45558; G06F 21/62; G06F 2212/1052; G06F 21/575

(57) ABSTRACT

The disclosed computer-implemented method for providing secure memory may include reserving, by a hypervisor stored in a memory device of the computing device, a portion of the memory device as a secure memory during a boot sequence of the computing device and preventing access to the secure memory by an operating system (OS). The method may include receiving a request for secure memory by an application and reserving a portion of the secure memory for the application. The method may include authenticating the application to access the reserved portion of the secure memory, and allowing the authenticated application to access the reserved portion of the secure memory. Various other methods, systems, and computer-readable media are also disclosed.

### BACKGROUND

Computers have become essential tools in various tasks for processing data. Computers are now commonly used for the storing, processing, and transmitting of important data, which may be confidential, proprietary, or otherwise private. The prevalence of computers have made computers increasingly attractive targets for attack.

Operating systems (OS) run on computers and manage resources, such as memory allocation, access to storage, and processor cycles, network bandwidth, etc., for applications running on the OS. For example, when an application runs on the OS, the OS provides the application memory by allocating a specific portion of available memory to the application. Each application normally accesses only the portion of memory allocated to the application by the OS. Attackers have found ways to exploit the OS to access memory allocated to other applications. For example, once the OS is breached, any data kept in memory may be viewable by the attacker. Similarly, access to storage may also be exploitable, as attackers may exploit the OS to access restricted portions of the storage.

Conventionally, the OS protects important data in memory and/or storage by restricting access, for instance by establishing privileges for specific users and/or applications. However, attackers may find ways to bypass privileges. Encrypting the data may provide additional security such that even if an attacker is able to access the data, the attacker would need to decrypt the data. However, encryption alone may not be foolproof as attackers may find ways to bypass encryption. For example, an attacker with access to encrypted data may examine different states of the encrypted data to find ways of bypassing encryption.

The instant disclosure, therefore, identifies and addresses a need for systems and methods for providing secure memory.

### SUMMARY

As will be described in greater detail below, the instant disclosure describes various systems and methods for providing secure memory.

In one example, a method for providing secure memory may include (1) reserving, by a hypervisor stored in a memory device of the computing device, a portion of the memory device as a secure memory during a boot sequence of the computing device, (2) preventing access to the secure memory by an operating system (OS), (3) receiving a request for secure memory by an application, (4) reserving a portion of the secure memory for the application, (5) authenticating the application to access the reserved portion of the secure memory, and (6) allowing the authenticated application to access the reserved portion of the secure memory.

In some examples, authenticating the application may include authenticating only a portion of executable code of the application requiring secure memory access such that the authenticated application comprises only the authenticated portion of the executable code.

In some examples, the method may include hiding the secure memory from the OS. In some examples, the method may include expanding, based on a request from the authenticated application, the reserved portion of the secure memory based on a remaining portion of the memory.

In some examples, the method may include allowing only the authenticated application to access the reserved portion of the secure memory. In some examples, the method may include (7) detecting another application attempting to access the reserved portion of the secure memory, and (8) performing a security action in response to the detection.

In some examples, the method may include maintaining the reserved portion of the secure memory as secure non-volatile memory after the computing device shuts down. In some examples, the computing device may include a storage device, the secure memory may comprise secure non-volatile memory and reserving the portion of the memory device may include reserving the portion of the memory device as the secure non-volatile memory from the storage device. In some examples, the method may include encrypting the secure non-volatile memory.

In one embodiment, a system for providing secure memory may include one or more processors, a memory device, and a hypervisor, stored in the memory device. The hypervisor may be configured to (1) reserve a portion of the memory device as a secure memory during a boot sequence of the system, (2) prevent access to the secure memory by an operating system (OS), (3) receive a request for secure memory by an application, (4) reserve a portion of the secure memory for the application, (5) authenticate the application to access the reserved portion of the secure memory, and (6) allow the authenticated application to access the reserved portion of the secure memory.

In some examples, authenticating the application may include authenticating only a portion of executable code of the application requiring secure memory access such that the authenticated application comprises only the authenticated portion of the executable code. In some examples, the hypervisor may be configured to allow only the authenticated portion of the executable code to access the reserved portion of the secure memory.

In some examples, the secure memory may be hidden from the OS. In some examples, the hypervisor may be configured to expand, based on a request from the authenticated application, the reserved portion of the secure memory based on a remaining portion of the memory. In some examples, the hypervisor may be configured to (7) detect another application attempting to access the reserved portion of the secure memory, and (8) perform a security action in response to the detection.

In some examples, the system may include a storage device, the secure memory may comprise secure non-volatile memory, and the hypervisor may be configured to reserve the portion of the memory device as the secure non-volatile memory from the storage device. In some examples, the hypervisor may be configured to maintain the reserved portion of the secure non-volatile memory after the system shuts down. In some examples, the secure non-volatile memory may be encrypted.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) reserve, by a hypervisor stored in a memory device of the computing device, a portion of the memory device as a secure memory during a boot sequence of the computing device (2) prevent access to the secure memory by an operating system (OS), wherein the secure memory is hidden from the OS, (3) receive a request for secure memory by an application, (4) reserve a portion of the secure memory for the application, (5) authenticate a portion of executable code of the application requiring secure memory access to access the reserved portion of the secure memory, and (6) allow only the authenticated code to access the reserved portion of the secure memory.

In some examples, the instructions may further comprise instructions for expanding, based on a request from the authenticated code, the reserved portion of the secure memory based on a remaining portion of the memory.

In some examples, the instructions may further comprise instructions for (7) detecting another application attempting to access the reserved portion of the secure memory, and (8) performing a security action in response to the detection.

In some examples, the computing device may include a storage device, the secure memory may comprise secure non-volatile memory and the instructions for reserving the portion of the memory device may comprise instructions for reserving the portion of the memory device as the secure non-volatile memory from the storage device. In some examples, the instructions may further comprise instructions for encrypting the secure non-volatile memory. In some examples, the instructions may further comprise instructions for maintaining the reserved portion of the secure non-volatile memory after the computing device shuts down.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for providing secure memory.

FIG. 2 is a flow diagram of an example method for providing secure memory.

FIG. 3 is a diagram of secure memory access according to one or more of the embodiments described and/or illustrated herein.

FIGS. 4A-4D are diagrams of memory allocation according to one or more of the embodiments described and/or illustrated herein.

FIG. 5 is a block diagram of an example computing system capable of implementing one or more of the embodiments described and/or illustrated herein.

FIG. 6 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown byway of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for providing secure memory. Applications often access and process sensitive data in memory and/or storage. Applications often run under the assumption that the operating system (OS) sufficiently protects the sensitive data in memory and/or storage. However, attackers may exploit weaknesses in the OS and/or the applications without alerting the OS and/or the applications. For example, the OS may allocate portions of memory to each application without securing the memory such that any application may view or otherwise access the memory allocated to another application. A compromised application may therefore be able to access the sensitive data.

As will be explained in greater detail below, by reserving portions of memory outside of the purview of the OS, the systems and methods described herein may be able to provide secure memory. By preventing the OS from accessing the secure memory, the OS may not be exploited to access the secure memory.

In addition, the systems and methods described herein may improve the functioning of a computing device by reducing processing and more efficiently providing secure memory without having to greatly modify the OS and avoiding an associated overhead for running a greatly modified OS. These systems and methods may also improve the field of data security by providing a secure memory scheme.

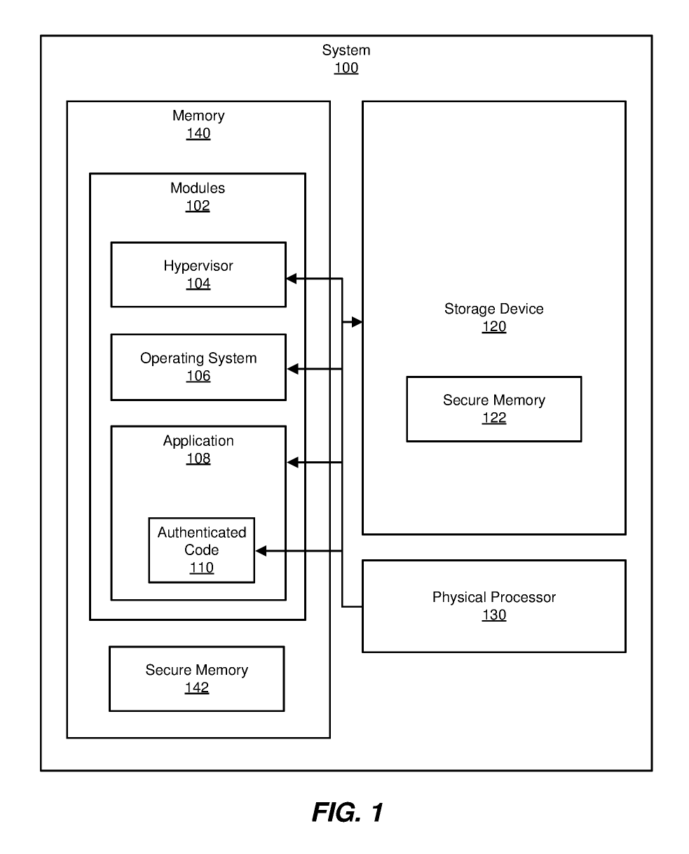

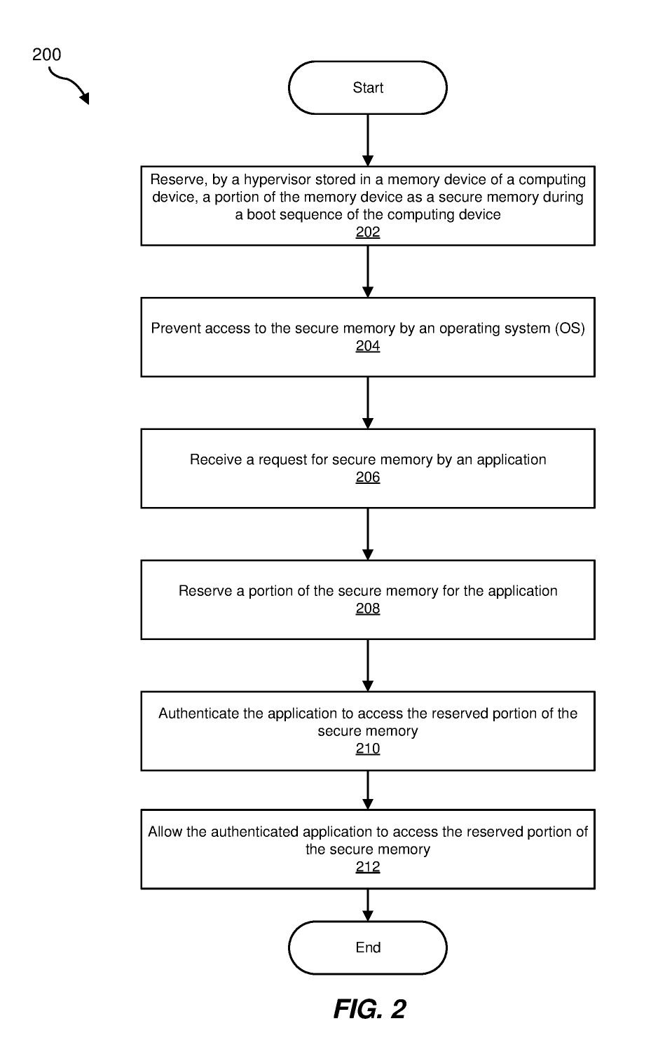

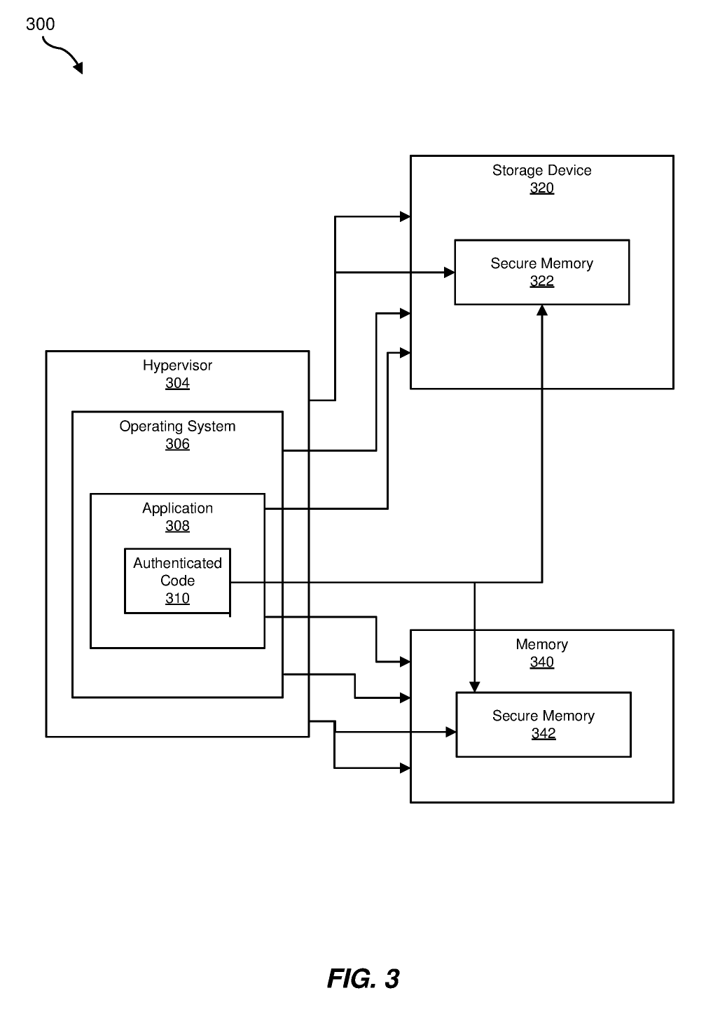

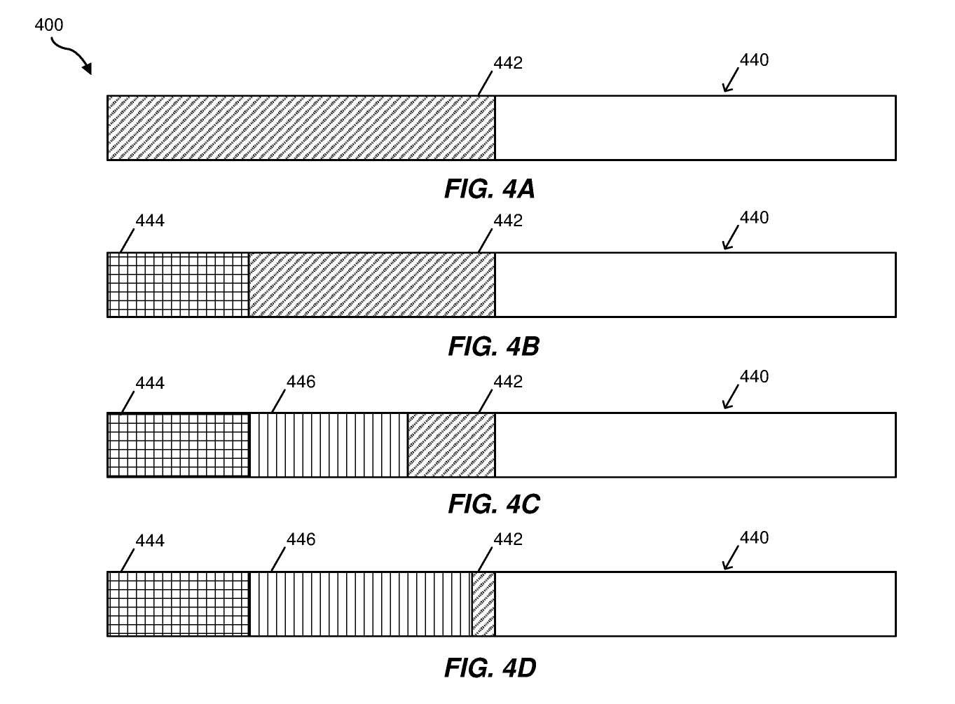

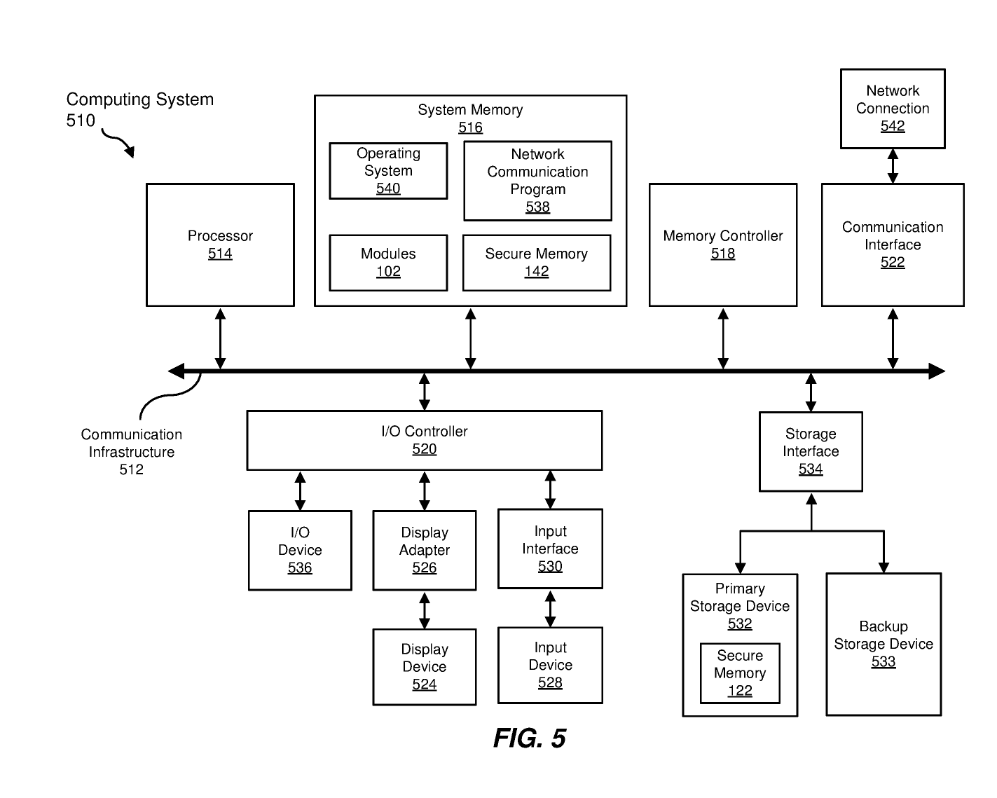

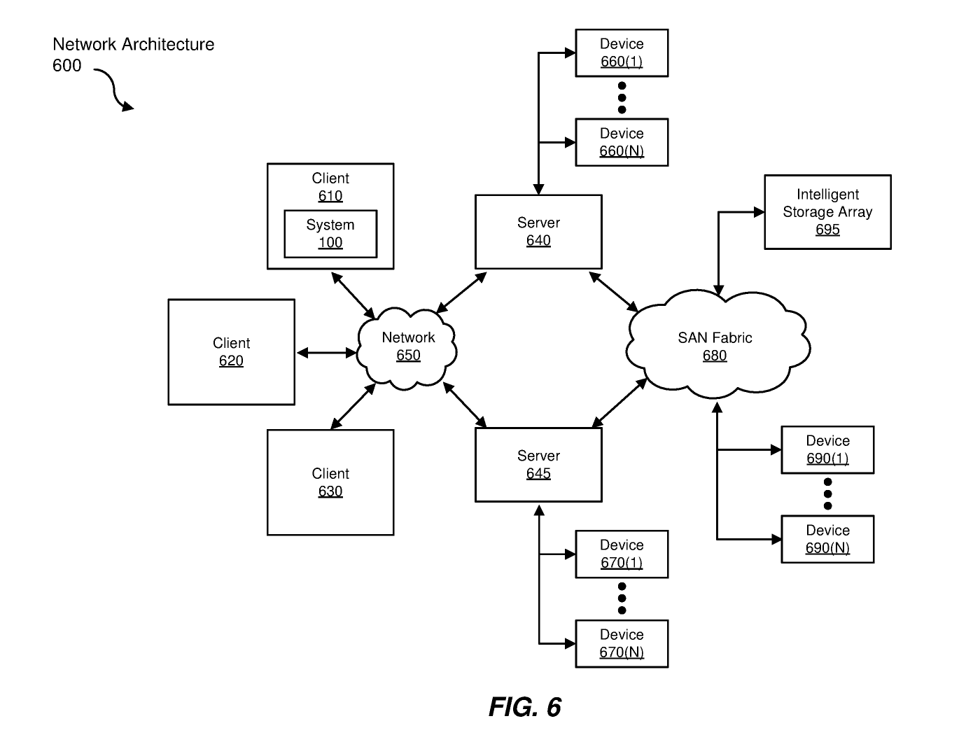

The following will provide, with reference to FIG. 1, detailed descriptions of an example system for providing secure memory. Detailed descriptions of corresponding computer-implemented methods will also be provided in connection with FIG. 2. Detailed descriptions of secure memory access will be provided in connection with FIG. 3. Detailed descriptions of memory allocation for secure memory will be provided in connection with FIG. 4. In addition, detailed descriptions of an example computing system and network architecture capable of implementing one or more of the embodiments described herein will be provided in connection with FIGS. 5 and 6, respectively.

FIG. 1 is a block diagram of an example system 100 for providing secure memory. As illustrated in this figure, example system 100 may include one or more modules 102 for performing one or more tasks. As will be explained in greater detail below, modules 102 may include a hypervisor 104, an operations system (OS) 106, and an application 108, which may include authenticated code 110. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 6 (e.g., clients 610, 620, 630, device 670(1), device 690(1), and/or server 640 and 645). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory. Example system 100 may also include secure memory 142. As will be explained further below, secure memory 142 may be a reserved portion of memory 140 which hypervisor 104 may restrict access to.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate providing secure memory. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include storage device 120. Storage device 120 generally represents any type or form of volatile or non-volatile storage device or medium capable of storing data and/or computer-readable instructions. In one example, storage device 120 may store, load, and/or maintain one or more of modules 102. Examples of storage device 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory. Example system 100 may also include secure memory 122. As will be explained further below, secure memory 122 may be a reserved portion of storage device 120 which hypervisor 104 may restrict access to.

Example system 100 in FIG. 1 may be implemented in a variety of ways. For example, all or a portion of example system 100 may represent portions of a database server keeping sensitive data in memory. In one example, all or a portion of the functionality of modules 102 may be performed by a computing device, server, and/or any other suitable computing system. As will be described in greater detail below, one or more of modules 102 from FIG. 1 may, when executed by at least one processor of system 100, enable system 100 to provide secure memory. For example, and as will be described in greater detail below, one or more of modules 102 may cause system 100 to recite steps of method claim using FIG. 2.

System 100 generally represents any type or form of computing device capable of reading computer-executable instructions. Additional examples of system 100 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Additional examples of system 100 include, without limitation, security servers, application servers, web servers, storage servers, and/or database servers configured to run certain software applications and/or provide various security, web, storage, and/or database services. Although illustrated as a single entity in FIG. 1, system 100 may include and/or represent a plurality of servers and/or computing devices that work and/or operate in conjunction with one another.

System 100 may communicate to other computing devices through a network, which may generally represent any medium or architecture capable of facilitating communication or data transfer, and may include wireless and/or wired connections. Examples of such a network include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 2 is a flow diagram of an example computer-implemented method 200 for providing secure memory. The steps shown in FIG. 2 may be performed by any suitable computer-executable code and/or computing system, including system 100 in FIG. 1, and/or variations or combinations of one or more of the same. In one example, each of the steps shown in FIG. 2 may represent an algorithm whose structure includes and/or is represented by multiple sub-steps, examples of which will be provided in greater detail below.

As illustrated in FIG. 2, at step 202 one or more of the systems described herein may reserve, by a hypervisor stored in a memory device of the computing device, a portion of the memory device as a secure memory during a boot sequence of the computing device. For example, hypervisor 104 may, as part of system 100 in FIG. 1, reserve secure memory 142 from memory 140, and/or secure memory 122 from storage device 120 during a boot sequence of system 100.

The term “hypervisor,” as used herein, generally refers to computer software, hardware, firmware, or a combination thereof, that isolates or abstracts operating systems and application from the underlying computer hardware of a host machine. Examples of hypervisors include, without limitation, virtual machine monitors (VMM), virtual machine (VM) control programs, and other virtualization systems in which hardware systems are presented through software systems.

The term “boot sequence,” as used herein, generally refers to an initialization sequence for a computing device, which may include finding and initializing connected devices, including storage devices, and may end with loading an OS. Examples of boot sequences include, without limitations, boot loaders, and other initialization software for loading operating systems.

The systems described herein may perform step 202 in a variety of ways. In one example, hypervisor 104 may run before operating system 106 or any other software, such as application 108, is loaded. By running during the boot sequence, and before operating system 106 is loaded, hypervisor 104 may run independently from operating system 106. In addition, as hypervisor 104 reserves secure memory 142 and/or secure memory 122 during the boot sequence, during which other devices such as memory 140 and storage device 120 are initialized, secure memory 142 and/or secure memory 122 may also be initialized as separate from memory 140 and storage device 120.

FIGS. 4A-4D shows a memory system 400, which may correspond to a memory system of system 100, which may include memory 140 and/or storage device 120. Memory system 400 may include a memory 440, which may correspond to memory 140 and/or storage device 120. Memory 440 may represent a total memory available.

As depicted in FIG. 4A, a secure memory 442 may be reserved from memory 440, for example by hypervisor 104 during the boot sequence. The reserved portion for secure memory 442 may be a fraction of memory 440, as reserving an entirety of memory 440 may leave no memory space available for other applications, such as operating system 106. For example, if memory 440 is 4 GB, secure memory 442 may be 1 GB.

A size of secure memory 442 may be determined to ensure enough memory space is available for other applications, such as operating system 106, to run without being hampered by a lack of memory space. In addition, the size of secure memory 442 may be determined to ensure enough secure memory space is available for applications requiring and/or requesting secure memory. For example, hypervisor 104 may be configurable to reserve at least a threshold amount of secure memory. Alternatively, hypervisor 104 may track secure memory requests to determine how much secure memory to reserve during the boot sequence.

As illustrated in FIG. 2, at step 204 one or more of the systems described herein may prevent access to the secure memory by an operating system (OS). For example, hypervisor 104 may, as part of system 100 in FIG. 1, prevent operating system 106 from accessing secure memory 142 and/or secure memory 122.

The systems described herein may perform step 204 in a variety of ways. In one example, secure memory 142 and/or secure memory 122 may be hidden from operating system 106. In other words, operating system 106 may not discover and/or access secure memory 142 and/or secure memory 122. For example, hypervisor 104 may configure secure memory 142 and/or secure memory 122 as separate virtual memory spaces, and allow operating system 106 access to other memory spaces, such as the remaining portions of memory 140 and/or storage device 120. Alternatively, hypervisor 104 may keep track of memory addresses associated with secure memory 142 and/or secure memory 122, and may prevent operating system 106 from accessing such memory addresses, for example by establishing memory address translation tables which omit such memory addresses.

Turning to FIG. 4A, operating system 106 may be able to discover and access the unreserved portions of memory 440, but may not be able to discover and/or access secure memory 442. To operating system 106, the underlying hardware may appear to comprise the unreserved portions of memory 440. By preventing operating system 106 from accessing secure memory 442, secure memory 442 may be protected from exploits to operating system 106.

Returning to FIG. 2, at step 206 one or more of the systems described herein may receive a request for secure memory by an application. For example, application 108 may, as part of system 100 in FIG. 1, request secure memory from hypervisor 104. After the boot sequence, operating system 106 may be loaded, and application 108 may run on operating system 106.

The systems described herein may perform step 206 in a variety of ways. In one example, application 108 may communicate with hypervisor 104 through an application programming interface (API).

The term “API,” as used herein, generally refers to protocols, tools, and/or subroutine definitions for a set of defined methods of communication between software components. Examples of application programming interfaces include, without limitation, software libraries, software frameworks, etc.

Hypervisor 104 may run independently from operating system 106 for example on an abstraction layer on top of operating system 106. The API may allow application 108 to communicate directly to hypervisor 104 and bypass operating system 106 such that operating system 106 is not aware of such communication and may also not be aware of hypervisor 104. For example, the API may establish a specific channel for supporting memory access bypassing operating system 106. The API may run in a user or kernel mode to allow access to the secure memory. In certain implementations, the hypervisor may maintain a pre-determined list of applications allowed to use the API.

Application 108 may request from hypervisor 104 a specific amount of secure memory, such as 100 MB out of 1 GB of secure memory 442. Alternatively, application 108 may request a predetermined amount of secure memory, which may be, for example, a parameter in the API. In addition, in certain implementations, application 108 may request one or more types of secure memory, such as secure memory 142 which may be volatile memory, and/or secure memory 122, which may be non-volatile memory.

As illustrated in FIG. 2, at step 208 one or more of the systems described herein may reserve a portion of the secure memory for the application. For example, hypervisor 104 may, as part of system 100 in FIG. 1, reserve a portion of secure memory 142 and/or secure memory 122 for application 108, based on the request.

The systems described herein may perform step 208 in a variety of ways. In one example, hypervisor 104 may maintain a memory address translation table, such as a hash table, in which memory addresses corresponding to the reserved portions are allocated to application 108.

The term “hash table,” (or “hash map”) as used herein, generally refers to a data structure implementing an associative array abstract data type mapping keys to values. A hash function, which may be a function mapping data of arbitrary size to data of fixed size, may be used for indexing the hash table. Examples of hash tables include, without limitation, associative arrays, database indices, caches, etc.

Hypervisor 104 may reserve the portion of secure memory for application 108 based on an availability of secure memory. For example, in FIG. 4B, a reserved portion 444 may have be previously reserved, for instance for another application, when hypervisor 104 receives the request from application 108. Hypervisor 104 may be limited by a global limit, such as the size of secure memory 442, from reserving any amount of secure memory. In addition, hypervisor 104 may not reserve portions of secure memory already reserved for another application. Thus, in FIG. 4C, hypervisor 104 may reserve a reserved portion 446 for application 108. Reserved portion 446 may not exceed the global limit, and further does not overlap reserved portion 444. Application 108 may not discover and/or access reserved portion 444. In addition, operating system 106 may not discover and/or access reserved portion 444 and/or reserved portion 446.

Changing the size of secure memory 442, for example expanding or reducing the size, may require a reboot. For example, operating system

Returning to FIG. 2, at step 210 one or more of the systems described herein may authenticate the application to access the reserved portion of the secure memory. For example, hypervisor 104 may, as part of system 100 in FIG. 1, authenticate application 108 to access the reserved portion of secure memory 142 and/or secure memory 122. Accessing the secure memory may include accessing and/or modifying the secure memory, such as reading from and/or writing to the secure memory, and/or changing a size of the secure memory, and/or freeing the secure memory.

The systems described herein may perform step 210 in a variety of ways. In one example, authenticating the application may comprise authenticating only a portion of executable code of the application requiring secure memory access such that the authenticated application comprises only the authenticated portion of the executable code. For example, hypervisor 104 may authenticate authenticated code 110 of application 108 for accessing secure memory 142 and/or secure memory 122. Authenticated code 110 may correspond to portions of the executable code of application 108 which requires access to secure memory 142 and/or secure memory 122. To further minimize an attack surface of application 108, only portions of application 108 may be granted access to secure memory 142 and/or secure memory 122.

Authenticated code 110 may be identified as executable code of application 108 which may be expected to access the requested secure memory. In some implementations, the API may require application 108 to identify or otherwise mark authenticated code 110 as specifically the portions of code requiring secure memory access. In some implementations, the request for secure memory may be from authenticated code 110.

Authentication may be based on a hash, certificate, or other indicator unique to application 108 and/or authenticated code 110 to uniquely identify and verify application 108 and/or authenticated code 110. In addition, secure memory 142 and/or secure memory 122, more specifically reserved portion 446, may also be authenticated to verify the secure memory.

As illustrated in FIG. 2, at step 212 one or more of the systems described herein may allow the authenticated application to access the reserved portion of the secure memory. For example, hypervisor 104 may, as part of system 100 in FIG. 1, allow application 108 and/or authenticated code 110 to access the reserved portion of secure memory 142 and/or secure memory 122.

The systems described herein may perform step 212 in a variety of ways. In one example, only the authenticated application may be allowed to access the reserved portion of the secure memory.

Once authenticated, only authenticated code 110 may request input/output (I/O) on reserved portion 446. In certain implementations, hypervisor 104 may verify every I/O request to reserved portion 446 to ensure that only authenticated code 110 accesses reserved portion 446, and to prevent any other application or portions of code of application 108 from accessing reserved portion 446. In certain implementations, the access rights to the secure memory may be defined by allowed entry points, which may correspond to memory locations of the code requesting access. For example, execution locations of authenticated code 110 may be verified to authenticate access rights of authenticated code 110.

In certain other implementations, the hypervisor may detect another application attempting to access the reserved portion of the secure memory and perform a security action in response to the detection. For instance, hypervisor 104 may detect if code or application other than authenticated code 110 accesses reserved portion 446. In response, hypervisor 104 may perform a security action, such as logging and/or reporting the unauthorized access attempt, stopping all access to or otherwise quarantining reserved portion 446.

In some implementations, the API may allow expanding, based on a request from the authenticated application, the reserved portion of the secure memory based on a remaining portion of the memory. For example, authenticated code 110 may request additional secure memory, for instance expanding reserved portion 446. If enough unreserved secure memory 442 is available, reserved portion 446 may be expanded to satisfy the request, as seen in FIG. 4D.

Other requests may include freeing reserved portion 446, for example when secure memory is no longer required or when system 100 shuts down, or reducing reserved portion 446. When reserved portion 446 is freed, the memory locations corresponding to reserved portion 446 may be wiped, for example to prevent subsequent access and analysis to discover what data may have been stored in reserved portion 446.

In certain implementations, the API may be different for secure non-volatile memory, which may also be referred to as persistent secure memory or secure storage. For example, secure storage may require maintaining the reserved portion of the secure memory after the computing device shuts down. The computing device may comprise a storage device, the secure memory may comprise secure non-volatile memory, and reserving the portion of the memory device may comprise reserving the portion of the memory device as the secure non-volatile memory from the storage device.

For example, hypervisor 104 may reserve secure memory 122 from storage device 120. Similar to secure memory 142, secure memory 122 may not be discoverable and/or accessible to operating system 106 or other applications. Hypervisor 104 may authenticate authenticated code 110 and/or secure memory 122 for secure storage access. Secure memory 122, or the reserved portion thereof, may be maintained after system 100 shuts down and/or reboots.

Because the secure storage may be persistent, for instance when the hypervisor is not active, the secure storage may be encrypted. For example, secure memory 122 may be encrypted such that data written to secure memory 122 is encrypted before writing to secure memory 122. In certain implementations, data read from secure memory 122 may be decrypted in response to read requests from authenticated code 110.

FIG. 3 illustrates a system 300 depicting access rights for various modules and/or components. System 300 may correspond to system 100. System 300 may include hypervisor 304, operating system 306, application 308, authenticated code 310, storage device 320, secure memory 322, memory 340, and secure memory 342, which may correspond, respectively, to hypervisor 104, operating system 106, application 108, authenticated code 110, storage device 120, secure memory 122, memory 140, and secure memory 142.

As seen in FIG. 3, hypervisor 304 may run on a lower level than operating system 306, such that hypervisor 304 may monitor activity on system 300, including operating system 306. For instance, hypervisor 304 may access storage device 320, secure memory 322, memory 340, and secure memory 342. Operating system 306 may have access to storage device 320 and memory 340, but not be aware of secure memory 322 and/or secure memory 342.

Application 308 may run on operating system 306. Application 308 may be given access to storage device 320 and memory 340 by operating system 306. However, authenticated code 310 may be given access to secure memory 322 and/or secure memory 342 by hypervisor 304.

As explained above, certain applications which process sensitive data may require secure memory. An OS may normally provide memory to applications, but may be vulnerable to attacks which may expose data in memory. To prevent such vulnerability, a hypervisor, which loads before the OS, may reserve portions of the memory as secure memory. The secure memory may be hidden from the OS such that the secure memory may not be breached through the OS. An API may allow specific sections of code from applications to access portions of the secure memory specifically allocated for the sections of code. Requiring the sections of code to be authenticated, and restricting access to the portions of the secure memory to only the authenticated section of code, may reduce an attack surface for the secure memory. When secure storage is needed, the hypervisor may similarly restrict access to portions of the secure storage only to the corresponding authenticated sections of code. The secure storage may also be encrypted, to protect the data when the hypervisor is not running. Thus, the systems and methods described herein may provide secure memory for applications processing sensitive data.

FIG. 5 is a block diagram of an example computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 2). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the example embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below). In one example, one or more of modules 102 from FIG. 1 may be loaded into system memory 516.

In some examples, system memory 516 may store and/or load an operating system 540 for execution by processor 514. In one example, operating system 540 may include and/or represent software that manages computer hardware and software resources and/or provides common services to computer programs and/or applications on computing system 510. Examples of operating system 540 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

As illustrated in FIG. 5, computing system 510 may also include at least one display device 524 coupled to I/O controller 520 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, example computing system 510 may also include at least one input device 528 coupled to I/O controller 520 via an input interface 530. Input device 528 generally represents any type or form of input device capable of providing input, either computer or human generated, to example computing system 510. Examples of input device 528 include, without limitation, a keyboard, a pointing device, a speech recognition device, variations or combinations of one or more of the same, and/or any other input device.

Additionally or alternatively, example computing system 510 may include additional I/O devices. For example, example computing system 510 may include I/O device 536. In this example, I/O device 536 may include and/or represent a user interface that facilitates human interaction with computing system 510. Examples of I/O device 536 include, without limitation, a computer mouse, a keyboard, a monitor, a printer, a modem, a camera, a scanner, a microphone, a touchscreen device, variations or combinations of one or more of the same, and/or any other I/O device.

Communication interface 522 broadly represents any type or form of communication device or adapter capable of facilitating communication between example computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

In some examples, system memory 516 may store and/or load a network communication program 538 for execution by processor 514. In one example, network communication program 538 may include and/or represent software that enables computing system 510 to establish a network connection 542 with another computing system (not illustrated in FIG. 5) and/or communicate with the other computing system by way of communication interface 522. In this example, network communication program 538 may direct the flow of outgoing traffic that is sent to the other computing system via network connection 542. Additionally or alternatively, network communication program 538 may direct the processing of incoming traffic that is received from the other computing system via network connection 542 in connection with processor 514. In some examples, secure memory 142 may be allocated from system memory 516.

Although not illustrated in this way in FIG. 5, network communication program 538 may alternatively be stored and/or loaded in communication interface 522. For example, network communication program 538 may include and/or represent at least a portion of software and/or firmware that is executed by a processor and/or Application Specific Integrated Circuit (ASIC) incorporated in communication interface 522.

As illustrated in FIG. 5, example computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510. In some examples, secure memory 122 may be allocated from primary storage device 532, although in other examples secure memory 122 may also be allocated from backup storage device 533.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 510 may be configured as an Application Specific Integrated Circuit (ASIC) adapted to implement one or more of the example embodiments disclosed herein.

FIG. 6 is a block diagram of an example network architecture 600 in which client systems 610, 620, and 630 and servers 640 and 645 may be coupled to a network 650. As detailed above, all or a portion of network architecture 600 may perform and/or be a means for performing, either alone or in combination with other elements, one or more of the steps disclosed herein (such as one or more of the steps illustrated in FIG. 2). All or a portion of network architecture 600 may also be used to perform and/or be a means for performing other steps and features set forth in the instant disclosure.

Client systems 610, 620, and 630 generally represent any type or form of computing device or system, such as example computing system 510 in FIG. 5. Similarly, servers 640 and 645 generally represent computing devices or systems, such as application servers or database servers, configured to provide various database services and/or run certain software applications. Network 650 generally represents any telecommunication or computer network including, for example, an intranet, a WAN, a LAN, a PAN, or the Internet. In one example, client systems 610, 620, and/or 630 and/or servers 640 and/or 645 may include all or a portion of system 100 from FIG. 1.

As illustrated in FIG. 6, one or more storage devices 660(1)-(N) may be directly attached to server 640. Similarly, one or more storage devices 670(1)-(N) may be directly attached to server 645. Storage devices 660(1)-(N) and storage devices 670(1)-(N) generally represent any type or form of storage device or medium capable of storing data and/or other computer-readable instructions. In certain embodiments, storage devices 660(1)-(N) and storage devices 670(1)-(N) may represent Network-Attached Storage (NAS) devices configured to communicate with servers 640 and 645 using various protocols, such as Network File System (NFS), Server Message Block (SMB), or Common Internet File System (CIFS).

Servers 640 and 645 may also be connected to a Storage Area Network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 645, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to example computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the example embodiments disclosed herein may also be encoded as a computer program, stored in server 640, run by server 645, and distributed to client systems 610, 620, and 630 over network 650.

As detailed above, computing system 510 and/or one or more components of network architecture 600 may perform and/or be a means for performing, either alone or in combination with other elements, one or more steps of an example method for providing secure memory.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive memory address data to be transformed, transform the memory address data, output a result of the transformation to a hash table, use the result of the transformation to allocate secure memory, and store the result of the transformation to manage the secure memory. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for providing secure memory, at least a portion of the method being performed by a computing device comprising at least one processor, the method comprising:
reserving, by a hypervisor stored in a memory device of the computing device, a portion of the memory device as a secure memory during a boot sequence of the computing device;
preventing access to the secure memory by an operating system (OS);
receiving a request for secure memory by an application;
reserving a portion of the secure memory for the application;
authenticating the application to access the reserved portion of the secure memory; and
allowing the authenticated application to access the reserved portion of the secure memory.

2. The method of claim 1, wherein authenticating the application comprises authenticating only a portion of executable code of the application requiring secure memory access such that the authenticated application comprises only the authenticated portion of the executable code.

3. The method of claim 1, further comprising hiding the secure memory from the OS.

4. The method of claim 1, further comprising expanding, based on a request from the authenticated application, the reserved portion of the secure memory based on a remaining portion of the memory.

5. The method of claim 1, further comprising allowing only the authenticated application to access the reserved portion of the secure memory.

6. The method of claim 1, further comprising:
detecting another application attempting to access the reserved portion of the secure memory; and
performing a security action in response to the detection.

7. The method of claim 1, further comprising maintaining the reserved portion of the secure memory as secure non-volatile memory after the computing device shuts down.

8. The method of claim 1, wherein the computing device comprises a storage device, the secure memory comprises secure non-volatile memory and wherein reserving the portion of the memory device comprises reserving the portion of the memory device as the secure non-volatile memory from the storage device.

9. The method medium of claim 1, wherein the secure memory comprises secure non-volatile memory and the method further comprises encrypting the secure non-volatile memory.

10. A system for providing secure memory, the system comprising:
one or more processors;
a memory device;
a hypervisor, stored in the memory device, configured to:
reserve a portion of the memory device as a secure memory during a boot sequence of the system;
prevent access to the secure memory by an operating system (OS);
receive a request for secure memory by an application;
reserve a portion of the secure memory for the application;
authenticate the application to access the reserved portion of the secure memory; and
allow the authenticated application to access the reserved portion of the secure memory.

11. The system of claim 10, wherein:
authenticating the application comprises authenticating only a portion of executable code of the application requiring secure memory access such that the authenticated application comprises only the authenticated portion of the executable code; and
the hypervisor is configured to allow only the authenticated portion of the executable code to access the reserved portion of the secure memory.

12. The system of claim 10, wherein the secure memory is hidden from the OS.

13. The system of claim 10, wherein the hypervisor is configured to expand, based on a request from the authenticated application, the reserved portion of the secure memory based on a remaining portion of the memory.

14. The system of claim 10, wherein the hypervisor is configured to:
detect another application attempting to access the reserved portion of the secure memory; and
perform a security action in response to the detection.

15. The system of claim 10, wherein:
the system comprises a storage device and the secure memory comprises a secure non-volatile memory;
the hypervisor is configured to reserve the portion of the memory device as the secure non-volatile memory from the storage device; and
the hypervisor is configured to maintain the reserved portion of the secure non-volatile memory after the system shuts down.

16. The system of claim 10, wherein the secure memory comprises secure non-volatile memory and the secure non-volatile memory is encrypted.

17. A non-transitory computer-readable medium comprising one or more computer-executable instructions that, when executed by at least one processor of a computing device, cause the computing device to:
reserve, by a hypervisor stored in a memory device of the computing device, a portion of the memory device as a secure memory during a boot sequence of the computing device;
prevent access to the secure memory by an operating system (OS), wherein the secure memory is hidden from the OS;
receive a request for secure memory by an application;
reserve a portion of the secure memory for the application;
authenticate a portion of executable code of the application requiring secure memory access to access the reserved portion of the secure memory; and
allow only the authenticated code to access the reserved portion of the secure memory.

18. The non-transitory computer-readable medium of claim 17, wherein the instructions further comprise instructions for expanding, based on a request from the authenticated code, the reserved portion of the secure memory based on a remaining portion of the memory.

19. The non-transitory computer-readable medium of claim 17, wherein the instructions further comprise instructions for:
detecting another application attempting to access the reserved portion of the secure memory; and
performing a security action in response to the detection.

20. The non-transitory computer-readable medium of claim 17, wherein:
the computing device comprises a storage device and the secure memory comprises secure non-volatile memory;
the instructions for reserving the portion of the memory device comprise instructions for reserving the portion of the memory device as the secure non-volatile memory from the storage device;
the instructions further comprise instructions for encrypting the secure non-volatile memory; and
the instructions further comprise instructions for maintaining the reserved portion of the secure non-volatile memory after the computing device shuts down.
